(19) United States
(12) Patent Application Publication
(10) Pub. No.: US 2012/0141816 A1
(43) Pub. Date: Jun. 7, 2012

(54) METHOD FOR PULSED ELECTROCHEMICAL MACHINING

(75) Inventors: Timur Rashitovich IDRISOV, Ufa (RU); Vyacheslav Alexandrovich ZAYTSEV, Ufa (RU)

(73) Assignee: PECM INDUSTRIAL, LLC, Ufa (RU)

(21) Appl. No.: 13/097,673

(22) Filed: Apr. 29, 2011

(30) Foreign Application Priority Data
Dec. 2, 2010 (RU) 2010149363

(51) Int. Cl. C25F 3/06; C25F 7/00; B32B 3/30; C25F 3/02

(52) U.S. Cl. 428/600; 205/642; 204/223

(57) ABSTRACT

The invention is related to the field of pulsed electrochemical machining of steels and alloys and can be used for performing various precision copying and piercing operations for manufacturing intricate profile surfaces of machine and tool workpieces made of hard-to-machine materials. The method comprises the steps of applying microsecond current pulse packages synchronized with an instant when the machining electrode and a workpiece are moved to a minimum distance towards each other, measuring at least one concordant voltage and current value in each pulse, calculating corresponding values of an interelectrode gap resistance, and adjusting the machining process in accordance with the changes of the interelectrode gap resistance. During the machining process, amplitude-time pulse parameters are adjusted in accordance with the changes of the shape of an interelectrode gap resistance curve during a pulse supply, said curve shape being considered as an accuracy criterion for copying the shape of the machining electrode. Amplitude-time pulse parameters can be adjusted by increasing a current pulse amplitude and controlling a ratio of a duration of a voltage rise to a duration of a steady-state process, or by increasing a voltage pulse duration and controlling a ratio of a duration of a current decrease to a duration of a steady-state process. In addition, an amplitude or duration of a pulse of an opposite polarity can be adjusted. The invention allows improving the copying accuracy and increasing the machining performance when the copying accuracy is predetermined.

### CROSS-REFERENCE TO RELATED APPLICATION

This application claims the benefits from the Russian Patent Application RU 2010149363 filed on Dec. 2, 2010. The content of this application is hereby incorporated by reference and in its entirety.

### BACKGROUND OF THE INVENTION

The invention relates to the field of pulsed electrochemical machining (ECM) of steels and alloys and can be used for performing various precision copying and piercing operations for manufacturing intricate profile surfaces of machine and tool workpieces made of hard-to-machine materials, e.g. tempered steels and alloys.

A method of electrochemical dimensional machining is known in which the machining is carried out using a pulse power supply with a steep current-voltage characteristic while one of the electrodes is oscillated and voltage pulses are applied during the phase when the electrodes are moved towards each other, wherein the current voltage pulse value is controlled by selecting voltage spikes at the sites where the electrodes are moved towards each other and moved apart from each other, respectively, the voltage spike values being adjusted by changing the electrolyte pressure at the entry of an interelectrode gap. (SU 717847, IPC B23H 3/02, 1977).

A method for electrochemical dimensional machining is known in which the machining is carried out using a pulse power supply with a steep current-voltage characteristic while one of the electrodes is oscillated and voltage pulses are applied during the phase when the electrodes are moved towards each other, wherein the current voltage pulse value is controlled by selecting voltage spikes at the sites where the electrodes are moved towards each other and moved apart from each other, respectively, a pulse supply is adjusted with respect to a moment when the electrodes are moved to a minimum distance towards each other by delaying the pulse supply when a voltage spike is present at the site where the electrodes are moved towards each other, the pulse voltage is applied in advance when a voltage spike is present at the site where the electrodes are moved apart from each other, the machining electrode (EDM electrode) feed rate being increased until the third local voltage extremum is formed in the middle of the pulse and maintained so that the voltage spike does not exceed a voltage value in the middle of the pulse by more than 20% (RU 2038928, IPC B23H 3/02, publ. Jul. 10, 1995).

Since the above methods use long pulses (with a duration of several ms) they do not allow obtaining reliable information about the critical minimum interelectrode gap (IEG) value at which a short-circuit occurs between the electrodes when using microsecond pulses or microsecond pulse packages which do not allow reducing the minimum IEG value and, therefore, obtaining maximum accuracy and quality. When long (˜1-10 ms) pulses are used, the interelectrode gap is filled with anodic dissolution products such as sludge and a vapor-gas mixture during the pulses, and the electrolyte temperature is increased. If the interelectrode gaps are small the process stability is deteriorated which results in a decrease of performance, quality and shaping accuracy of the surface to be machined.

A method of electrochemical machining in which a machining electrode is located at a predetermined distance from the workpiece electrode surface is also known. During the machining, electric current pulses are passed between the machining electrode and the workpiece electrode. The parameters characterizing the current intensity, e.g. resistance, are measured and taken as criteria for an interelectrode distance (gap). According to this method, an instant is detected when the current intensity characteristics during a corresponding voltage pulse initially exceed a comparative set of characteristics having a similar form thereto, followed by a fall below said set of characteristics, which is taken into account as an interelectrode gap criterion. [WO 02/086198-PCT/DE02/01450 IPC B23H3/00, publ. Oct. 31, 2002].

However, the known method is ineffective when using in the machining process a group of pulses, since analysis of variations of the current intensity characteristics, e.g. resistance, does not provide in this case reliable information on the current interelectrode gap (IEG) properties. Moreover, when using a group of microsecond pulses (10 μs and less) it is generally impossible to determine an initial exceeding and further decrease of the current intensity characteristics with respect to the comparative value on the basis of separate pulses. The evaluation of an interelectrode gap on the basis of the initial exceeding and further decrease below the comparative value is a strictly particular case. It is related to the fact that the variation of the current intensity during separate pulses depends both on properties of the used electrolyte and the composition of the workpiece to be machined. Therefore, the known method does not give reliable information about the minimum interelectrode gap value that allows reliably carrying out the machining process and increasing its performance, accuracy and quality characteristics.

Thus, the known methods of electrochemical machining do not provide sufficient accuracy and performance when the machining accuracy is predetermined during the process of shaping intricate profile surfaces in case when microsecond pulses are used and an oscillating electrode movement is synchronized with the pulse package supply because these methods do not reliably maintain small interelectrode gaps without occurrence of short-circuits and breakdowns of interelectrode gaps.

The closest to the present method is a method of electrochemical machining of heat-resistant alloys with an oscillating machining electrode comprising the steps of applying microsecond voltage pulse packages synchronized with an instant when the machining electrode and a workpiece are moved to a minimum distance towards each other, measuring at least one concordant voltage and current value in each pulse, evaluating corresponding values of an interelectrode gap resistance, and adjusting a machining electrode feed rate during the machining process in accordance with the changes of the shapes of envelope curves, said envelope curves being built using the values of interelectrode gap resistance for conjugate points of pulses (Russian patent No. 2266177, International Patent Classification B23H 3/00, publication date 20.12.2005).

The known method allows carrying out the machining process in case of small interelectrode gaps. However, during the machining of intricate profile workpieces having small (less than 1 mm) components, particularly the components with a height to width ratio larger than 1, the known method does not provide high copying accuracy of said components because a dissolution process occurs at each local site of the workpiece including the sites with a minimum interelectrode gap and sites located at a distance from the machining electrode surface, i.e. due to a poor localization of the dissolution process. Thus, the known machining method does not allow controlling the electrochemical machining process localization, and the machining process carried out in accordance with the known method leads to smoothing of the profile of a small component and does not allow obtaining the maximum copying accuracy.

### BRIEF SUMMARY OF THE INVENTION

The object of the present invention is to improved the copying accuracy and machining performance when the copying accuracy of intricate profile surfaces is predetermined, by ensuring a high rate of localization of the electrochemical dissolution process.

The above-mentioned object is achieved by providing a method for pulsed electrochemical machining of steels and alloys with an oscillating machining electrode comprising the steps of applying microsecond current pulse packages synchronized with an instant when the machining electrode and a workpiece are moved to a minimum distance towards each other, measuring at least one concordant voltage and current value in each pulse, calculating corresponding values of an interelectrode gap resistance, and adjusting the machining process in accordance with the changes of the interelectrode gap resistance, characterized in that the machining process is carried out by adjusting amplitude-time pulse parameters in accordance with the changes of the shape of an interelectrode gap resistance curve during a pulse, said curve shape being considered as an accuracy criterion for copying the shape of the machining electrode.

In accordance with one embodiment of the invention, a predefined copying accuracy is attained by fixing a voltage waveform when a rectangular current pulse is applied and increasing a pulse duration while simultaneously measuring a duration of a voltage rise and a duration of a steady-state process until a moment when a ratio of the duration of the voltage rise to the duration of the steady-state process equals a predefined value.

In accordance with one embodiment of the invention, a predefined copying accuracy is obtained by fixing a voltage waveform when a rectangular voltage pulse is applied and increasing a pulse duration while measuring a duration of a current decrease and a duration of a steady-state process until a moment when a ratio of the duration of the current decrease to the duration of the steady-state process equals a predefined value.

In accordance with one embodiment of the invention, a predefined copying accuracy and high process productivity are obtained by setting a ratio of a duration of a voltage rise to a duration of a steady-state process to be larger than 0.9 at the initial step of the machining process, and to be less than 0.5 at the final step of the machining process.

In accordance with one embodiment of the invention, a predefined copying accuracy is obtained by fixing a voltage waveform when a rectangular current pulse is applied and increasing a current pulse amplitude while measuring a duration of a voltage raise and a duration of a steady-state process until a moment when a ratio of the duration of the voltage raise to the duration of the steady-state process equals a predefined value.

In accordance with one embodiment of the invention, a predefined copying accuracy is obtained by fixing a current waveform when a rectangular voltage pulse is applied and increasing a voltage pulse amplitude while measuring a duration of a current decrease and a duration of a steady-state process until a moment when a ratio of the duration of the current decrease to the duration of the steady-state process equals a predefined value.

In accordance with one embodiment of the invention, a predefined copying accuracy is obtained by fixing a current waveform when a rectangular voltage pulse is applied and increasing a machining electrode feeding speed while measuring a duration of a current decrease and a duration of a steady-state process until a moment when a ratio of the duration of the current decrease to the duration of the steady-state process equals a predefined value.

In accordance with one embodiment of the invention, a predefined copying accuracy is obtained by fixing a current waveform when a rectangular voltage pulse is applied and increasing a duration of a pulse of an opposite polarity while measuring a duration of a current decrease and a duration of a steady-state process until a moment when a ratio of the duration of the current decrease to the duration of the steady-state process equals a predefined value.

In accordance with one embodiment of the invention, a predefined copying accuracy is obtained by fixing a current waveform when a rectangular voltage pulse is applied and increasing the amplitude of a pulse of an opposite polarity while measuring a duration of a current decrease and a duration of a steady-state process until a moment when a ratio of the duration of the current decrease to the duration of the steady-state process equals a predefined value.

The present method for electrochemical machining allows performing various copying and piercing operations with workpieces made of hard-to-machine steels and alloys while ensuring high accuracy and performance of the machining by adjusting a duration of the interelectrode gap resistance setting process (setting of the electrode potentials and charge of the double electric layer capacitance) to a duration of the steady-state process (the beginning of the anodic dissolution process) providing information about the dissolution process localization. The localization of the dissolution process at a predetermined interelectrode gap value univocally characterizes the electrochemical machining accuracy.

### BRIEF DESCRIPTION OF THE SEVERAL VIEWS OF THE DRAWINGS

The present invention is further elucidated by specific embodiments thereof described with references to the accompanying drawings, in which:

FIG. 1 is a schematic diagram showing voltage and current oscillograms corresponding to the interelectrode gap when a voltage source (a) and current source (b) are operated;

FIG. 2 shows voltage and current oscillograms corresponding to the interelectrode gap in case of the following conditions: the machining electrode and workpiece electrode are made of steel of 12X18H9T type; the electrolyte comprises 8% NaNO₃; the current intensity is 20 A/cm², the pulse frequency is 10 Hz (a), 100 Hz (b) and 100 Hz, the pulse of opposite polarity has a duration of 50 μs and intensity of 2 A/cm² (c).

FIG. 3 shows voltage and current oscillograms corresponding to the interelectrode gap when (a) the dissolution occurs and (b) the dissolution does not occur (t* is the charging time of to total double electric layer capacitance), the workpiece material is 12X18H10T, the electrolyte comprises 20% NaNO₃, the pulse duration is 20 μs, the current intensity is 80 A/cm² (a) and 40 A/cm² (b).

### DETAILED DESCRIPTION OF THE INVENTION

The invention is illustrated for better understanding by way of non-limiting example embodiments thereof, which are discussed in more detail below.

When a current or voltage pulse is applied to the electrochemical cell, the double electric layer of the anode and cathode is charged, and an electrochemical reaction occurs.

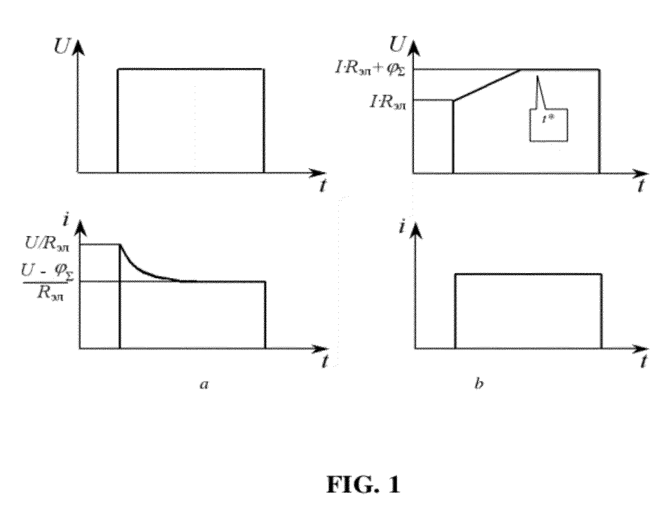

It can be assumed that when a pulse sequence is applied and a polarization within a pause between the pulses is not reduced to the steady-state value, the double electric layer capacitance is substantially constant. Then, when the capacitance is charged via the electrolyte column resistance Rₑₗ, the current gradually changes in accordance with an exponential law (FIG. 1, a).

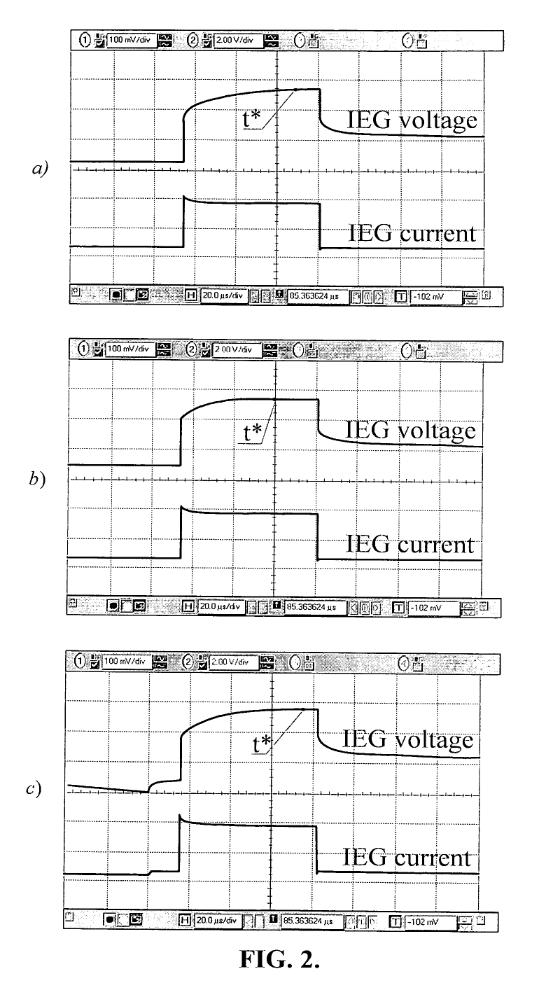

The analysis of the interelectrode gap voltage oscillogram shows that the source has a steep current-voltage characteristic, i.e. output source pulses have rectangular waveforms. When the capacitances of the anode and cathode of the double electric layer are charged by DC current, the voltage linearly increases before an instant t* when the dissolution potential is reached (FIG. 1, b and FIG. 2, a). When the pulse sequence frequency is increased the total double electric layer capacitance is not fully discharged and the charging time period t* is reduced (FIG. 2, b). When applying additional current pulses of opposite polarity between the operational pulses an accelerated discharge of the double electric layer capacitance occurs and time period t* is increased (FIG. 2, c). Thus, the pulse frequency (and thereby the machining performance) can be increased while maintaining the desired machining accuracy by applying pulses of opposite polarity.

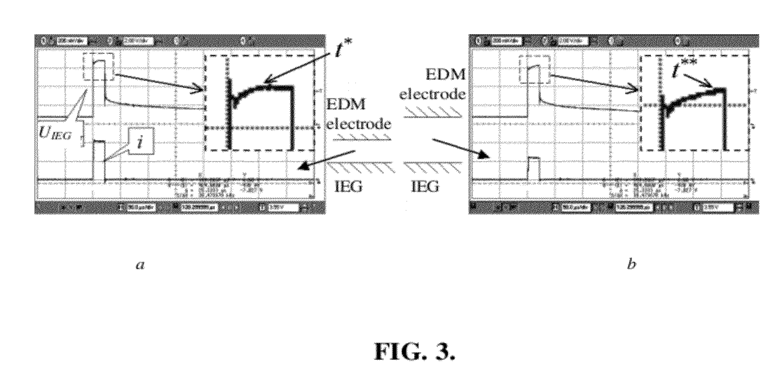

In order to achieve a predetermined machining accuracy the duration of the operational pulses is determined as follows (FIG. 3):

1) current intensity distribution in the interelectrode gap is evaluated;

2) current pulses having the intensity corresponding to the interelectrode gap area where the dissolution process is not to occur are applied to the electrochemical cell;

3) pulse duration is selected to be less than the duration of the charging time period t* of the double electric layer capacitance;

4) current pulses having the intensity corresponding to the interelectrode gap area where the dissolution process is to occur are applied to the electrochemical cell; a substantially horizontal region should then appear on the interelectrode gap voltage oscillogram that is related to the reaction of the metal dissolution.

### EXAMPLE OF A SPECIFIC EMBODIMENT

The present method for electrochemical machining was realized on an improved copy-piercing machine of SEP-905 type. The machining electrode was made of steel of 12X18H10T type and the workpiece to be machined was made of steel of 12X18H10T type. The area to be machined was set to 0.5 cm². The central electrolyte feeding was used. The current source was used as a power supply. The electrolyte was an aqueous 8% sodium nitrite solution.

Before the machining process, an oscillating machining electrode and workpiece being machined are moved to each other until their mutual contact without applying voltage thereto and then moved apart from each other at a predetermined value of the initial interelectrode gap Sₘᵢₙ₁ which is set to 20 μm.

Then the following mode was set up:
voltage pulse package frequency and machining electrode oscillation frequency are 50 Hz (the oscillation period T is 20 ms);
package duration tₚ=1 ms;
current pulse duration is 20 μs;
duration of a pause between the pulses tₚ=100 μs;
voltage pulse amplitude in the package Uₚ=8.5 V;
machining electrode oscillation amplitude Aᵥ=0.2 mm;
electrolyte pressure at the entry of the interelectrode gap is 100 kPa;
electrolyte temperature is 20° C.

During the electrochemical machining process, the current pulse duration was controlled and adjusted in such a manner that a ratio of a duration of an interelectrode gap resistance setting process (process of setting of the electrode potentials and charge of the double electric layer capacitance) to a duration of a steady-state process (beginning of the anodic dissolution process) is equal to 1. The processes occurring at the workpiece surface regions located at a distance more than 40 μm from the machining electrode surface do not relate to the metal dissolution, i.e. the dissolution processes are localized within 40 from the machining electrode surface. Such improving in dissolution process localization allows forming small components with a size of about 0.1 mm and a height to width ratio larger than 1 and, thus, allows increasing the copying accuracy. The method in accordance with the prototype does not allow providing such copying accuracy and, thereby, forming components with a size of about 0.1 mm.

Thus, the present invention allows improving the copying accuracy of intricate profile surfaces and increasing the machining performance when the copying accuracy is predetermined.

We claim:

1. A method for pulsed electrochemical machining of steels and alloys with an oscillating machining electrode, the method comprising the steps of applying microsecond current pulse packages synchronized with an instant when the machining electrode and a workpiece are moved to a minimum distance towards each other, measuring at least one concordant voltage and current value in each pulse, calculating corresponding values of an interelectrode gap resistance, and adjusting the machining process in accordance with the changes of the interelectrode gap resistance, wherein the machining process is carried out by adjusting amplitude-time pulse parameters in accordance with the changes of the shape of an interelectrode gap resistance curve during a pulse, said curve shape being considered as an accuracy criterion for copying the shape of the machining electrode.

2. A method as claimed in claim 1, wherein a predefined copying accuracy is obtained by fixing a voltage waveform when a rectangular current pulse is applied and increasing a pulse duration while simultaneously measuring a duration of a voltage rise and a duration of a steady-state process until a moment when a ratio of the duration of the voltage rise to the duration of the steady-state process equals a predefined value.

3. A method as claimed in claim 1, wherein a predefined copying accuracy is obtained by fixing a voltage waveform when a rectangular voltage pulse is applied and increasing a pulse duration while measuring a duration of a current decrease and a duration of a steady-state process until a moment when a ratio of the duration of the current decrease to the duration of the steady-state process equals a predefined value.

4. A method as claimed in claim 1, wherein a predefined copying accuracy and high process productivity are obtained by setting a ratio of a duration of a voltage rise to a duration of a steady-state process to be larger than 0.9 at the initial step of the machining process, and to be less than 0.5 at the final step of the machining process.

5. A method as claimed in claim 1, wherein a predefined copying accuracy is obtained by fixing a voltage waveform when a rectangular current pulse is applied and increasing a current pulse amplitude while measuring a duration of a voltage raise and a duration of a steady-state process until a moment when a ratio of the duration of the voltage raise to the duration of the steady-state process equals a predefined value.

6. A method as claimed in claim 1, wherein a predefined copying accuracy is obtained by fixing a current waveform when a rectangular voltage pulse is applied and increasing a voltage pulse amplitude while measuring a duration of a current decrease and a duration of a steady-state process until a moment when a ratio of the duration of the current decrease to the duration of the steady-state process equals a predefined value.

7. A method as claimed in claim 1, wherein a predefined copying accuracy is obtained by fixing a current waveform when a rectangular voltage pulse is applied and increasing a machining electrode feeding speed while measuring a duration of a current decrease and a duration of a steady-state process until a moment when a ratio of the duration of the current decrease to the duration of the steady-state process equals a predefined value.

8. A method as claimed in claim 1, wherein a predefined copying accuracy is obtained by fixing a current waveform when a rectangular voltage pulse is applied and increasing a duration of a pulse of an opposite polarity while measuring a duration of a current decrease and a duration of a steady-state process until a moment when a ratio of the duration of the current decrease to the duration of the steady-state process equals a predefined value.

9. A method as claimed in claim 1, wherein a predefined copying accuracy is obtained by fixing a current waveform when a rectangular voltage pulse is applied and increasing an amplitude of a pulse of an opposite polarity while measuring a duration of a current decrease and a duration of a steady-state process until a moment when a ratio of the duration of the current decrease to the duration of the steady-state process equals a predefined value.

10. An apparatus for pulsed electrochemical machining of steels and alloys with an oscillating machining electrode, the apparatus comprising
a current pulse generator for generating microsecond current pulse packages synchronized with an instant of maximum approach of the machining electrode and a workpiece,
a measurement unit for measuring at least one concordant voltage and current value in each pulse, calculating corresponding values of an interelectrode gap resistance, and adjusting the machining process in accordance with the changes of the interelectrode gap resistance,
a control unit for adjusting amplitude-time pulse parameters in accordance with the changes in the shape of an interelectrode gap resistance curve during a pulse, said curve shape being considered as an accuracy criterion for copying the shape of the machining electrode.

11. An article of manufacture having intricate profile surfaces, made of hard-to-machine materials, selected from tempered steels and alloys, obtained by a method of claim 1.
